(19) United States
(12) Patent Application Publication
(10) Pub. No.: US 2020/0032888 A1
(43) Pub. Date: Jan. 30, 2020

(54) FINAL DRIVE FOR A MOTOR VEHICLE

(71) Applicant: AUDI AG, Ingolstadt (DE)

(72) Inventors: Christian MEIXNER, Ingolstadt (DE); Dirk BRANDL, Wettstetten (DE); Jürgen TSCHULLIK, Berching (DE)

(73) Assignee: AUDI AG, Ingolstadt (DE)

(21) Appl. No.: 16/337,592

(22) PCT Filed: Sep. 25, 2017
(86) PCT No.: PCT/EP2017/074227

§ 371 Date: Mar. 28, 2019

(30) Foreign Application Priority Data
Sep. 28, 2016 (DE) 10 2016 218 731.7

(51) Int. Cl. F16H 48/12; B60K 17/16; B60B 35/14; B60B 35/12; F16H 48/42; F16H 57/021; F16H 57/037

(52) U.S. Cl. CPC F16H 48/12; B60K 17/165; B60B 35/14; B60B 35/122; F16H 2057/02052; F16H 57/021; F16H 57/037; F16H 2048/423; F16H 48/42

(57) ABSTRACT

A final drive for a motor vehicle, comprising a first input shaft, a second input shaft, a first output shaft, and a second output shaft, wherein the first input shaft is permanently coupled to the first output shaft by a first ring gear transmission and the second input shaft is permanently coupled to the second output shaft by a second ring gear transmission. The first input shaft and the second input shaft are arranged coaxial to each other and the first output shaft and the second output shaft extend from the respective ring gear transmissions in opposite directions, wherein an axis plane contains the axes of rotation of the input shafts and a plane perpendicular to the axis plane includes an angle of at least 75° and at most 90°.

The invention relates to a final drive for a motor vehicle for a motor vehicle, comprising a first input shaft, a second input shaft, a first output shaft, and a second output shaft, wherein the first input shaft is permanently coupled to the first output shaft by means of a first ring gear transmission and the second input shaft is permanently coupled to the second output shaft by means of a second ring gear.

The final drive is coordinated with an axle of the motor vehicle, such as a front axle, but preferably a rear axle of the motor vehicle. By means of the final drive, a torque is transmitted from a drive mechanism of the motor vehicle to wheels of the motor vehicle. Put another way, the final drive produces or at least can produce an operative connection between the drive mechanism of the motor vehicle and the axle or its wheels. The drive mechanism is coupled or at least can be coupled permanently to the first input shaft and the second input shaft. For example, the operative connection between the drive mechanism and the two input shafts is present through a transmission mechanism different from the final drive. The transmission mechanism may be designed, for example, as a differential transmission, especially an axle differential transmission. The two input shafts may accordingly be present as Cardan shafts or at least be coupled to Cardan shafts, especially in permanent manner For example, the two input shafts of the final drive are permanently coupled to the output shafts of the transmission mechanism, especially in rigid manner The two output shafts of the final drive are provided at the wheel side, i.e., arranged on a side of the ring gear transmission facing away from the drive mechanism in relation to the flow of torque. The first output shaft for example is associated with a first wheel of the axle and the second output shaft is associated with at least with a second wheel of the same axle, especially coupled to it in a permanent and/or rigid manner Of course, however, it may be provided that the operative connection between the first output shaft and the first wheel and/or the operative connection between the second output shaft and the second wheel can be broken at least temporarily. For this purpose, a shift clutch is provided in the operative connections, especially a claw clutch.

Within the final drive, the first input shaft is permanently coupled to the first output shaft and the second input shaft is permanently coupled to the second output shaft. The first ring gear transmission and the second ring gear transmission serve for this purpose. By means of the ring gear transmissions, an angled arrangement of the input shafts and the output shafts to each other is achieved. For example, it may be provided that the ring gear transmissions respectively have a hypoid offset, so that the output shafts are arranged with an offset relative to the input shafts, in particular they lie skew to them, i.e., they are arranged at a parallel spacing from them. However, this leads to a large design space requirement for the final drive.

The problem which the invention proposes to solve is to propose a final drive for a motor vehicle which has advantages over known final drives, especially a reliable mounting of the ring gear transmissions at the same time as having less design space requirement.

This is accomplished according to the invention by a final drive with the features of claim 1. It is provided that the first input shaft and the second input shaft are arranged coaxial to each other and the first output shaft and the second output shaft extend from the respective ring gear transmission in opposite directions, wherein an axis plane contains the axes of rotation of the input shafts and a plane perpendicular to the axis plane makes an angle of at least 75° and at most 90° with each of the axes of rotation of the output shafts, and that a first ring gear of the first ring gear transmission, which first ring gear is rigidly connected to the first output shaft, and/or a second ring gear of the second ring gear transmission, which second ring gear is rigidly connected to the second output shaft, is mounted in a transmission housing of the final drive in each case by means of a first radial bearing and a second radial bearing, which are arranged in tandem arrangement or in X arrangement to each other or are designed as a fixed bearing and as a floating bearing.

On the whole, therefore, there is provided a special arrangement of the input shafts and the output shafts as well as a special mounting of at least one of the ring gears, namely, the first ring gears and the second ring gears of the two ring gear transmissions. This arrangement, in turn, makes possible a special configuration of the transmission housing, which is multi-piece, for example. First of all, the two input shafts are arranged coaxial to each other. For example, the second input shaft extends in the first input shaft or vice versa. The two output shafts lie substantially opposite one another, especially in regard to the plane of symmetry, and they extend from the respective ring gear transmission in opposite directions, preferably in the direction of the corresponding wheel of the motor vehicle.

Both the axis of rotation of the first output shaft and the axis of rotation of the second output shaft for example intersect the two axes of rotation of the input shafts or the common axis of rotation of the input shafts. In other words, it is provided that axes of rotation of the output shafts each intersect the axes of rotation of the input shafts. Accordingly, the ring gear transmissions may be designed without a hypoid offset. However, a design with hypoid offset may also be realized, in which therefore at least the axis of rotation of one of the output shafts does not intersect the axes of rotation of the input shafts. Preferably, however, the axes of rotation of both output shafts do not intersect the axes of rotation of the input shafts in this case. Hence, on the whole, there is a skew arrangement of the axes of rotation of the output shafts relative to the axes of rotation of the input shafts.

In addition, now, it is provided that the (imaginary) axis plane contains the axes of rotation of the input shafts. The axis plane is arranged substantially horizontal in regard to the installed condition of the final drive. Accordingly, the plane perpendicular to the axis plane, and likewise containing the axes of rotation of the input shafts, is present as a vertical plane, i.e., it is arranged substantially vertically in the installed condition of the final drive. The plane perpendicular to the axis plane at least seem in sectional view, namely, especially in the cross section relative to the axes of rotation of the input shafts, makes an angle of at least 75° and at most 90° with the axes of rotation of the output shafts.

Each of the axes of rotation thus makes an angle with the plane that fulfills the mentioned preconditions. The angles between the axes of rotation and the plane may be identical, or alternatively they may be different from each other. For example, the angles amount to at least 75° and at most 90°. Preferably, the angle or the angles amount to at least 80°, at least 85°, at least 86°, at least 87°, at least 88° or at least 89°, but always at most 90°. This means that the angle or the angles may be precisely equal to 90° or also less than 90°.

In addition or alternatively, the plane perpendicular to the axis plane is the plane of symmetry for the axes of rotation of the output shafts at least when seen in sectional view, namely, in particular in the cross section relative to the axes of rotation of the input shafts. The axes of rotation of the output shafts in this case are thus oriented or arranged symmetrically to one another in regard to the plane of symmetry.

Now, the first ring gear is rigidly connected to the first output shaft and the second ring gear to the second output shaft. The first ring gear is part of the first ring gear transmission, the second ring gear is part of the second ring gear transmission. At least one of these ring gears, but preferably both ring gears, are now mounted in the transmission housing of the final drive, each time by means of two radial bearings, namely, the first radial bearing and the second radial bearing. The two radial bearings are situated in a tandem arrangement or in an X arrangement relative to each other. Alternatively, they may also be designed as a fixed bearing and as a floating bearing. In the latter case, one of the radial bearings forms the fixed bearing and the other of the radial bearings forms the floating bearing. Such an arrangement and/or configuration of the radial bearings enables a reliable and compact mounting of the ring gear or the ring gears on and/or in the transmission housing.

A further embodiment of the invention provides that the axes of rotation of the two input shafts and the axes of rotation of the two output shafts lie in the axis plane. This represents an especially advantageous orientation of the input shafts and the output shafts, allowing an extremely compact configuration of the final drive. If both the input shafts and the output shafts are arranged in the axis plane, the definition given above using the plane of symmetry is not needed. Accordingly, this is no longer necessary for the definition of the axis plane.

A further especially preferred embodiment of the invention provides that a bearing element is arranged in the transmission housing, comprising a first bearing boss and a second bearing boss, wherein the ring gear of the first ring gear transmission is mounted on the first bearing boss and the ring gear of the second ring gear transmission is mounted on the second bearing boss. In order to give the final drive an especially compact configuration, the bearing element is arranged in the transmission housing. The bearing element comprises the two bearing bosses, namely, the first bearing boss and the second bearing boss. The bearing bosses serve for the mounting of ring gears of the two ring gear transmissions. Accordingly, the first ring gear of the first ring gear transmission is mounted on the first bearing boss and the second ring gear of the second ring gear transmission is mounted on the second bearing boss. The mounting is preferably directly configured so that the respective ring gear sits on the corresponding bearing boss. However, alternatively a merely indirect mounting may be provided, in which for example the ring gears are mounted on the bearing boss via the respective output shaft. In such a configuration, the output shaft is mounted directly at or on the bearing boss. The mounting of the respective ring gear is provided only indirectly across the output shaft. For example, the ring gear may be spaced apart from the bearing boss in the axial direction with respect to its axis of rotation or the axis of rotation of the output shaft.

The first ring gear is rigidly joined to the first output shaft or alternatively forms a single piece with it. The same may be provided for the second ring gear and the second output shaft. The bearing element is a mechanism designed separately from the transmission housing. Thus, first of all the transmission housing and the bearing element are fabricated separately from each other and then the bearing element is arranged on or in the transmission housing. Preferably, the bearing element is arranged centrally in the transmission housing, especially centrally with respect to the axes of rotation of the two input shafts. In particular, the axes of rotation of the two input shafts extend through the bearing element, i.e., they intersect it. In order to make possible a simple arrangement of the bearing element in the transmission housing, the latter is preferably multi-piece and comprises for example a first housing shell and a second housing shell. The two bearing bosses for example are round in cross section with respect to their respective longitudinal center axis and preferably emerge in the axial direction from a center post of the bearing element. At their end facing away from the center post, the bearing bosses preferably have a free end.

A preferred embodiment of the invention provides that the first radial bearing is arranged on the first bearing boss or the second bearing boss for the mounting of the respective ring gear, and/or the second radial bearing is arranged on the transmission housing. Preferably, only one of the two radial bearings, i.e., the first radial bearing and the second radial bearing, is arranged on the first bearing boss, if it is serving for the mounting of the first ring gear, and on the second bearing boss, if it is provided for the mounting of the second ring gear.

By the arrangement of the radial bearing on the bearing boss is meant that it sits by its inner ring on the respective bearing boss. This means that its inner ring entirely encloses the bearing boss in the circumferential direction and lies against it preferably at least partly continuously, especially entirely continuously, in the circumferential direction. Conversely, this means that the outer ring of the radial bearing engages with the respective ring gear. Hence, a mounting of the ring gear on the transmission housing is provided at least partly via the corresponding bearing boss, so that the ring gear is mounted indirectly on the transmission housing, namely, across the respective bearing boss.

Preferably, the second radial bearing engages on the one hand with the transmission housing and on the other hand with the ring gear or the corresponding output shaft. For example, for this purpose the second radial bearing sits by its inner ring on the ring gear or the output shaft. The outer ring of the second radial bearing, on the other hand, may be fastened to the transmission housing.

Accordingly, it is especially preferably provided that one of the radial bearings is arranged on one of the bearing bosses and the other radial bearing engages with the transmission housing. Correspondingly, the ring gear mounted with the aid of the two radial bearings, namely, the first radial bearing and the second radial bearing, is mounted between the bearing boss and the transmission housing, namely, indirectly mounted. Preferably, in this regard, the ring gear is mounted across the first radial bearing directly on the first bearing boss and accordingly indirectly on the transmission housing. On the other hand, the ring gear is mounted across the second radial bearing directly on the transmission housing. This allows for an especially advantageous bracing of the ring gear or the ring gears in the axial direction with respect to their particular axis of rotation.

A further embodiment of the invention provides that the first radial bearing lies against an inner bearing face of the respective ring gear and the second radial bearing lies against an outer bearing face of the respective ring gear or the output shaft connected to the ring gear. The inner bearing face is formed by a region of the inner circumferential face of the ring gear. The ring gear accordingly has a recess formed coaxial to its axis of rotation or the axis of rotation of the corresponding output shaft. The radial bearing now engages with this recess. For this, preferably the respective bearing boss protrudes into the corresponding ring gear in the axial direction. For example, the bearing boss reaches through an end face of the ring gear, especially an end face of the ring gear facing toward the bearing element.

While the first radial bearing engages with or lies against the inner bearing face of the ring gear, the second radial bearing engages with the outer bearing face or lies against it. The outer bearing face is formed by an outer circumferential face of the ring gear or the output shaft, which is connected to the ring gear. Preferably, the first radial bearing lies against the ring gear or the output shaft, spaced apart in the axial direction from the second radial bearing. The two radial bearings should accordingly engage with the ring gear or the output shaft at places spaced apart in the axial direction, especially in order to prevent a tilting of the ring gear or the output shaft.

In a further embodiment of the invention it is provided that the first bearing boss and the second bearing boss emerge from a center post of the bearing element. The center post is accordingly present between the two bearing bosses, which emerge from it on opposite ends of the center post. For example, the center post is arranged roughly centrally in the transmission housing, preferably centrally with respect to the axes of rotation of the input shafts. Preferably the axes of rotation of the input shafts extend at least through the bearing element, but especially through the center post.

An especially preferred embodiment of the invention provides that the second radial bearing is braced against the transmission housing in the axial direction with respect to the axis of rotation of the respective ring gear. For this, the second radial bearing rests for example by its outer ring against the transmission housing, while it encloses the ring gear or the output shaft with its inner ring. For example, the transmission housing has an axial bearing boss, in order to secure the second radial bearing in the axial direction relative to the transmission housing, on the outside at least in the axial direction, that is, in the direction facing away from the bearing element. Preferably, moreover, the ring gear likewise comprises an axial bearing boss, so that the second radial bearing as a whole, looking in the axial direction, lies on the one hand against the axial bearing boss of the ring gear and on the other hand against the axial bearing boss of the transmission housing and the ring gear as a whole is secured or at least almost secured by the two radial bearings in the axial direction.

In a further embodiment of the invention it is provided that the bearing element, especially the center post, is fastened to the transmission housing, while the first radial bearing is connected to the transmission housing only via the bearing element. The bearing element is arranged in the transmission housing and secured to it. For example, the bearing element lies against the transmission housing at least for a portion. This holds especially for the center post. Preferably, the bearing element is secured by means of at least one screw to the transmission housing. For example, the transmission housing is multi-piece in design and accordingly it has a first housing shell and a second housing shell. The two housing shells are formed separately from each other and preferably lie against one another in a plane of contact, situated in the axis plane or being parallel to it.

It may now be provided that the bearing element is fastened to the first housing shell and to the second housing shell, in particular, on opposite sides of the plane of contact or each time by means of at least one screw, whose longitudinal center axis is angled relative to the plane of contact and/or stands perpendicular to it. It may furthermore be provided that the bearing element is respectively fastened to the first housing shell and/or the second housing shell on both sides of an imaginary plane situated perpendicular to the plane of contact and containing a point of intersection of the axes of rotation of the output shafts with the axes of rotation of the input shafts. The radial bearing arranged on the first bearing boss or the second bearing boss is now connected to the transmission housing solely via the bearing element.

Finally, in a further preferred embodiment of the invention it may be provided that the first radial bearing has a first inner diameter and a first outer diameter and the second radial bearing has a second inner diameter and a second outer diameter, while the first inner diameter is different from the second inner diameter and/or the first outer diameter is different from the second outer diameter. Preferably, however, the difference between the first outer diameter and the first inner diameter is equal to the difference between the second outer diameter and the second inner diameter, so that the two radial bearings have identical dimensions, looking in the radial direction.

It is preferably provided that the first inner diameter is larger than the second inner diameter and/or the first outer diameter is larger than the second outer diameter. The first radial bearing is accordingly larger in configuration than the second radial bearing, but preferably the difference between the inner diameter and the outer diameter of the two radial bearings is identical in the manner explained above.

The invention shall now be explained more closely with the aid of the exemplary embodiments represented in the drawing, without this limiting the invention. There are shown:

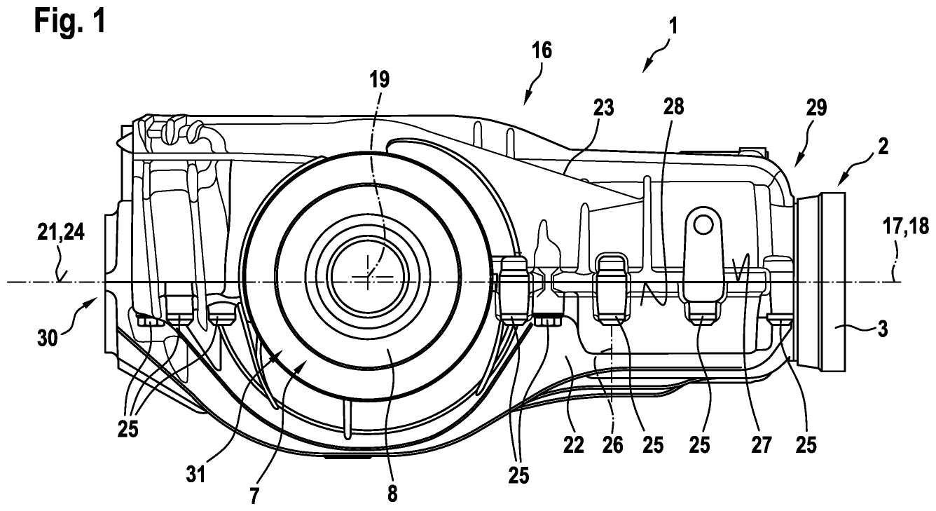

FIG. 1 a schematic side view of a final drive for a motor vehicle,

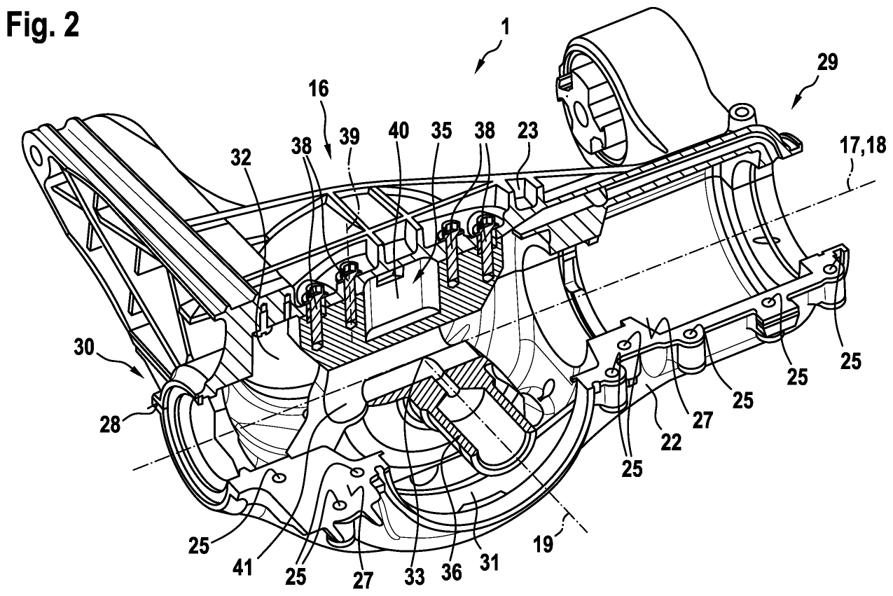

FIG. 2 a schematic cross sectional representation through a transmission housing and a bearing element arranged in the transmission housing,

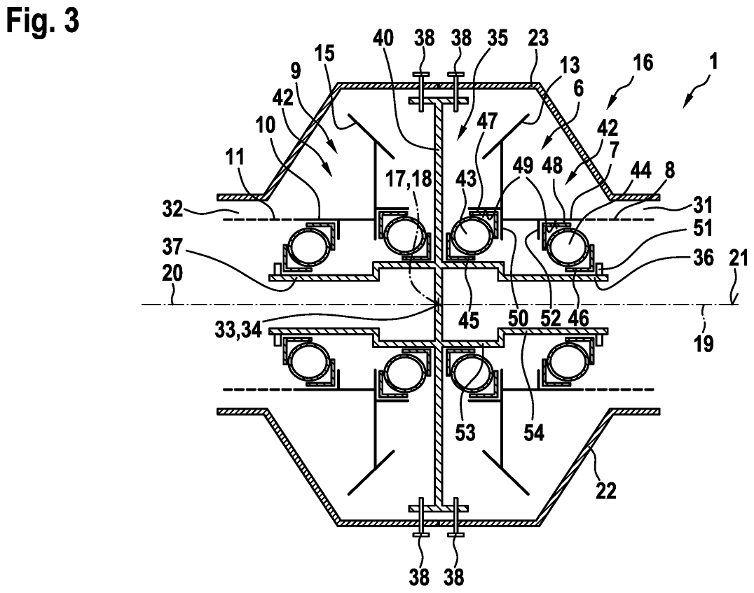

FIG. 3 a schematic representation of the final drive in a first embodiment,

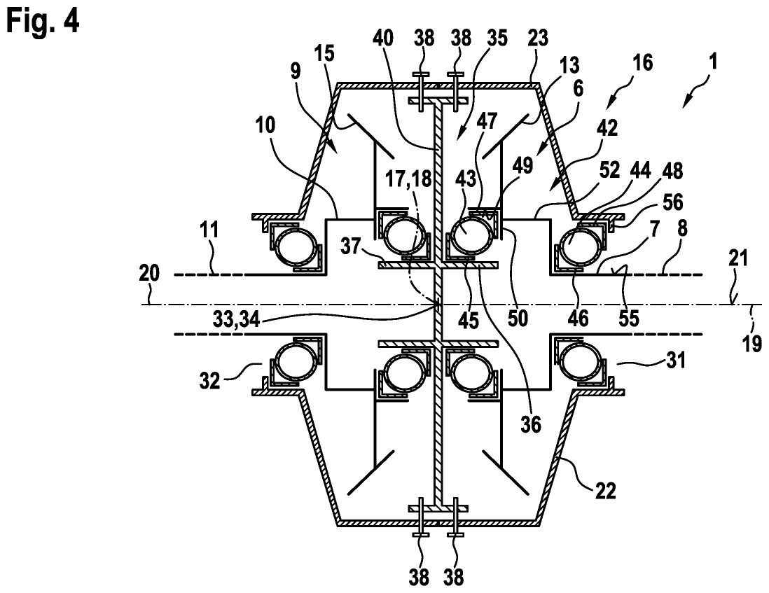

FIG. 4 a schematic representation of a second embodiment of the final drive,

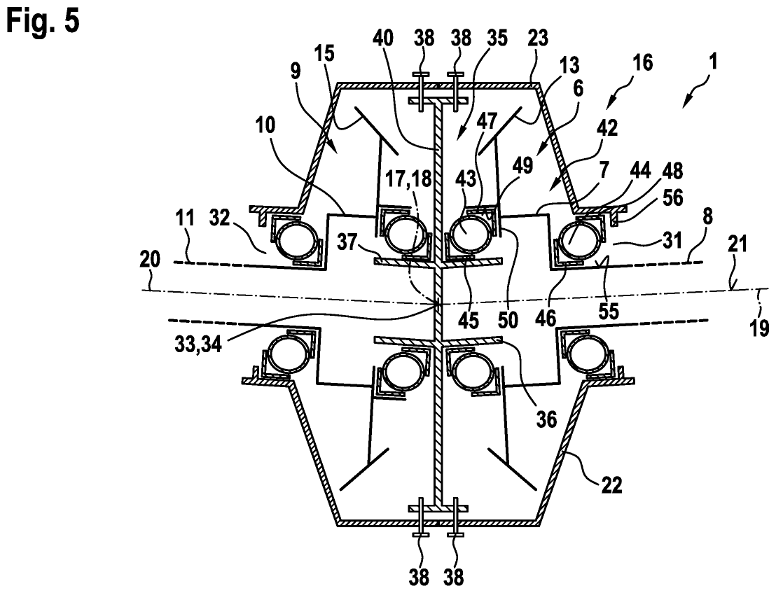

FIG. 5 a first variant of a third embodiment of the final drive in a schematic representation, and

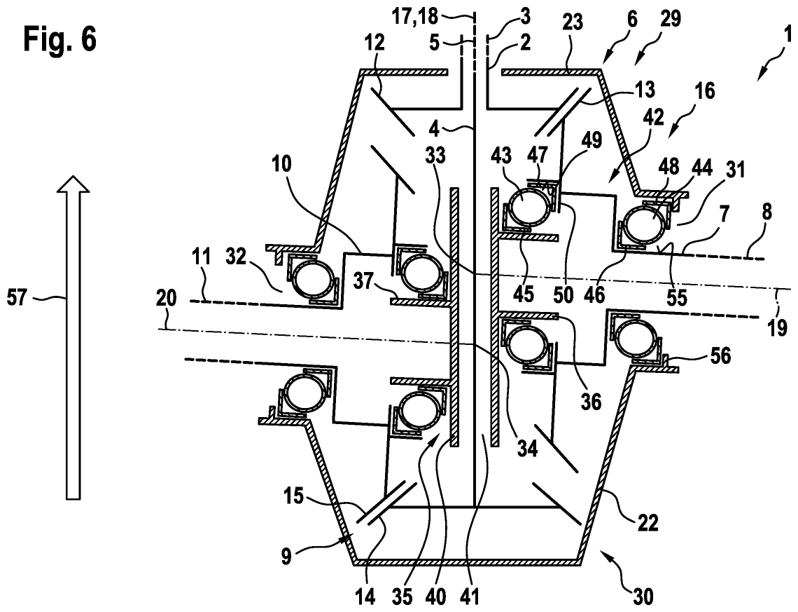

FIG. 6 a schematic representation of a second variant of the third embodiment of the final drive.

FIG. 1 shows a schematic side view of a final drive 1 for a motor vehicle. This comprises a first input shaft 2, of which a connection flange 3 is shown here. Coaxial to the first input shaft 2 is arranged a second input shaft 4 not visible here. The first input shaft 2 for this purpose is designed as a hollow shaft and the second input shaft 4 is arranged and/or mounted in the first input shaft 2. The second input shaft 4 has a connection flange 5, which is preferably arranged in the connection flange 3 of the first input shaft 2. The first input shaft 2 is permanently coupled by means of a first ring gear transmission 6 to a first output shaft 7. The first output shaft 7 has a connection flange 8, which can be seen here. Similarly, the second input shaft 4 is permanently coupled by means of a second ring gear transmission 9 to a second output shaft 10 permanent, not visible here, having a connection flange 11.

The first ring gear transmission 6 consists of a ring gear 12 coupled rigidly and permanently to the first input shaft 2 and a ring gear 13 meshing with the ring gear 12 and coupled rigidly and permanently to the first output shaft 7. Similarly, the second ring gear transmission 9 comprises a ring gear 14 coupled rigidly and permanently to the second input shaft 4 and a ring gear 15 meshing with the ring gear 14 and coupled rigidly and permanently to the second output shaft 10. The ring gear transmissions 6 and 9 and correspondingly the ring gears 12, 13, 14 and 15 are arranged in a transmission housing 16 of the final drive 1, especially arranged entirely therein. In other words, the transmission housing 16 encloses the ring gear transmissions 6 and 9 preferably entirely.

It has already been pointed out that the first input shaft 2 and the second input shaft 4 are arranged coaxial to each other, whereby the second input shaft 4 lies inside the first input shaft 2. The input shafts 2 and 4 thus have mutually coinciding axes of rotation 17 and 18.

The first output shaft 7 and the second output shaft 10 now extend from the respective ring gear transmission 6 or 9 in opposite directions. In the exemplary embodiment represented here, the first output shaft 7 thus extends out from the plane of the drawing, while the second output shaft 10 extends into the plane of the drawing. One axis of rotation 19 of the first output shaft 7 or each connection flange 8 is arranged slightly slanting in the vertical direction and intersects the axes of rotation 17 and 18. The same holds for an axis of rotation 20 of the second output shaft 10 or its connection flange 11, not recognizable here.

The input shafts 2 and 4 or their axes of rotation 17 and 18 lie in an axis plane 21, which is situated basically horizontal. Put another way, an imaginary plane stands perpendicular to the axis plane 21, being the plane of symmetry for the axes of rotation 19 and 20 of the output shafts 7 and 10, seen in sectional view, especially in the cross section with respect to the axes of rotation 17 and 18. The axes of rotation 19 and 20 are accordingly oriented and arranged symmetrically to this imaginary plane, which on account of the horizontal arrangement of the axis plane 21 can also be called the vertical plane.

Because the imaginary plane serves as the plane of symmetry for the axes of rotation 19 and 20, the axes of rotation 19 and 20 intersect both the plane of symmetry and the axis plane each time by the same angle. Put another way, the axis of rotation 19 thus makes a first angle with respect to the axis plane 21 or the plane of symmetry and the axis of rotation 20 makes a second angle with respect to the axis plane 21 or the plane of symmetry, the two angles being equal. Thus, quite generally, the axes of rotation 19 and 20 intersect the axis plane 21. It may also be provided that the axes of rotation 19 and 20 lie entirely in the axis plane 21.

In order to make possible a space-saving configuration of the final drive 1, the transmission housing 16 is multi-piece and comprises a first housing shell 22 and a second housing shell 23, which are fabricated separately from each other and rest against one another in a plane of contact 24, lying in the axis plane 21 or being parallel to it. The first housing shell 22 and the second housing shell 23 are joined together by means of at least one screw 25, in the exemplary embodiment shown here by means of a plurality of screws 25. At least one of the screws 25, but preferably all of the screws 25, now has a longitudinal center axis 26 which is angled relative to the plane of contact 24, i.e., which intersects it at a particular angle. Accordingly, it is not provided that the screw 25 or its longitudinal center axis 26 is arranged parallel to the plane of contact 24 or that the longitudinal center axis 26 lies in the plane of contact 24. Instead, especially preferably, the longitudinal center axis 26 stands perpendicular to the plane of contact 24. Furthermore, it is preferably provided that at least one of the screws 25 is penetrated by the plane of contact 24, i.e., it is intersected by the plane of contact 24.

This means, for the arrangement of the screw 25, that the screw is present at the side on the transmission housing 16 and not, for example, on a separate fastening flange provided on a top side or a bottom side of the transmission housing 16 for the fastening of the shells 22 and 23 to each other. No such fastening flange is provided in the advantageous configuration of the final drive 1 described here.

With such a configuration the design space requirement in the vertical direction, i.e., in the plane of symmetry, can be significantly reduced as compared to other final drives 1.

Against the first housing shell 22 lies a first bearing face 27, situated in the plane of contact 24, and against the second housing shell 23 lies a second bearing face 28, situated in the plane of contact 24. The two bearing faces 27 and 28 lie flush against each other, especially over the entire surface, after the assembling of the housing shells 22 and 23. By the full-surface arrangement is meant that the entire first bearing face 27 lies against the entire second bearing face 28. Each of the bearing faces 27 and 28 accordingly fully covers the respective other bearing face 28 or 27.

The screw 25 now passes through both the first bearing face 27 and the second bearing face 28. Accordingly, it engages with the first housing shell 22 and with the second housing shell 23 to fasten them to each other. In the exemplary embodiment represented here, it is provided that the first bearing face 27 extends in the direction of the axes of rotation 17 and 18 from one end 29 of the transmission housing 16 to its other end 30. In addition or alternatively, this holds for the second bearing face 28. Especially preferably, therefore, both the first bearing face 27 and the second bearing face 28 extend on the one hand as far as the end 29 and on the other hand as far as the end 30.

Between the ends 29 and 30, however, the bearing faces 27 and 28 may be interrupted. In the exemplary embodiment shown here, this is the case for both bearing faces on account of a first exit opening 31 for the first output shaft 7 or its connection flange 8 as well as a second exit opening 32 for the second output shaft 10 or its connection flange 11. The first output shaft 7 accordingly passes through the first exit opening 31 or is situated therein, while the second output shaft 10 passes through the second exit opening 32 or is situated therein.

Especially preferably, it is provided that the exit openings 31 and 32 are formed in equal parts in the housing shell 22 and the second housing shell 23. However, at least each of the exit openings 31 and 32 lies at least partly in the first housing shell 22 and at least partly in the second housing shell 23. The bearing faces 27 and 28 thus each comprise two partial faces, which are situated on opposite sides of the exit openings 31 and 32, looking in the axial direction with respect to the axes of rotation 17 and 18.

FIG. 2 shows a schematic partial sectional representation of a portion of the final drive 1. The input shafts 2 and 4 as well as the output shafts 7 and 10 are not shown here. This also applies to the ring gear transmissions 6 and 9. Basically, however, reference is made to the preceding remarks. It is now clearly recognizable here that the axis of rotation 19 intersects the axes of rotation 17 and 18 at a point of intersection 33. This also holds analogously for the axis of rotation 20 at a point of intersection 34 not shown here, which may coincide with the point of intersection 33.

Furthermore, it is now recognizable that a bearing element 35 is arranged in the transmission housing 16 in a preferred embodiment of the final drive 1. This comprises a first bearing boss 36 and, situated opposite to this, a second bearing boss 37, not recognizable here. Rotationally mounted on the first bearing boss 36 is the first ring gear 13, rigidly connected to the first output shaft 7, and on the second bearing boss 37 is mounted the ring gear 15 of the second ring gear transmission 9, rigidly connected to the second output shaft 10. The first bearing boss 36 protrudes in the direction of the first exit opening 31, in particular it protrudes into it or even passes through it in the direction of the axis of rotation 19. Conversely, the second bearing boss 37 protrudes in the direction of the second exit opening 32. It also may protrude into it or even pass through it in the direction of the axis of rotation 20.

The bearing element 35 is now fastened on the one hand to the first housing shell 22 and on the other hand to the second housing shell 23. The fastening occurs each time by means of at least one screw 38, preferably each time by means of several screws 38. This is recognizable here only for the fastening of the bearing element 35 to the second housing shell 23. Preferably, however, the corresponding remarks may be applied to the fastening of the bearing element 35 to the first housing shell 22. It can be seen that the screw 38 or the screws 38 each have a longitudinal center axis 39. The screw 38 or its longitudinal center axis 39 is now angled with respect to the plane of contact 24 (not shown here). In particular, it stands perpendicular to the plane of contact 24. This means therefore that the longitudinal center axis 39 of the screw 38 is oriented preferably parallel to the longitudinal center axis 26 of the screw 25.

The screw 38 engages in a center post 40 of the bearing element 35 in order to hold the bearing element 35 on the transmission housing 16. The bearing bosses 36 and 37 emerge from the center post 40 on opposite sides of the plane of symmetry. Furthermore, a through opening 41 may be formed in the center post 40, especially between the bearing bosses 36 and 37, to receive the second input shaft 4. Preferably, therefore, the second input shaft 4 passes entirely through the bearing element 35, especially its through opening 41, in the axial direction with respect to the axes of rotation 17 and 18.

The ring gear transmissions 6 and 9 are preferably configured such that the ring gears 12 and 14 connected to the input shafts 2 and 4 are present on opposite sides of the bearing element 35, i.e., on opposite sides of a plane perpendicular to the axes of rotation 17 and 18. In particular, the ring gear 12 lies entirely on one side of this plane and the ring gear 14 entirely on the opposite side of the plane. The bearing element 35 is preferably designed as a single piece and/or materially integrated. For example, it consists of the same material as the housing shells 22 and 23. The use of the bearing element 35 enables an especially compact configuration of the final drive 1, especially in the vertical direction.

FIG. 3 shows a schematic sectional representation of the final drive 1, namely, a cross section with respect to the axes of rotation 17 and 19, the sectioning plane standing perpendicular to the axes of rotation 17 and 18 and preferably containing the axes of rotation 19 and 20. The viewing direction in the cross section is oriented in the direction of the end 29. The input shafts 2 and 4 are not shown here. It can be seen that each of the ring gears 13 and 15 or each of the output shafts 7 and 10 is mounted by means of a bearing arrangement 42 in the transmission housing 16. The bearing arrangement 42 for the ring gears 13 and 15 and the corresponding output shafts 7 and 10 are configured analogously, but especially in mirror symmetry. We shall discuss more closely in the following the bearing arrangement 42 for the ring gear 13 and the first output shaft 7. However, the remarks may always be applied to the bearing arrangement 42 for the ring gear 15 and the second output shaft 10.

The bearing arrangement 42 comprises a first radial bearing 43 and a second radial bearing 44. These are situated in an O-arrangement relative to each other. Alternatively, they may also be designed as a fixed bearing and a floating bearing. In the latter case, one of the radial bearings 43 and 44 forms the fixed bearing and the other of the radial bearings 43 and 44 forms the floating bearing. In the following, however, we shall discuss the O-arrangement shown here. The remarks however may always be applied to the configuration of the radial bearings 43 and 44 as a fixed bearing and a floating bearing. The radial bearings 43 and 44 are preferably designed as roller bearings, especially as ball bearings.

The radial bearings 43 and 44 are both arranged on the first bearing boss 36. This means that they sit by their inner rings 45 and 46 on the first bearing boss 36. The outer rings 47 and 48 of the radial bearings 43 and 44, on the other hand, are arranged in the ring gear 13 and/or the first output shaft 7. Accordingly, the outer rings 47 and 48 lie against an inner bearing face 49 of the ring gear 13 or the first output shaft 7. It is provided that the first radial bearing 43 is braced in the axial direction with respect to the axis of rotation 19 against the center post 40 of the bearing element 35. In other words, the first radial bearing 43 is arranged in the axial direction with respect to the axis of rotation 19 between the center post 40 and the ring gear 13 or an axial bearing boss 50 of the ring gear 13. In particular, the radial bearing 43 lies permanently against the center post 40 and on the other hand permanently against the axial bearing boss 50.

The second radial bearing 44 is preferably secured by a fastening means 51 on the outside in the axial direction, i.e., in the direction facing away from the center post 40. The fastening means 51 used is for example a snap ring or the like. In particular, the fastening means 51 is releasable. The radial bearing 44 is preferably arranged between the fastening means 51 and the ring gear 13 or an axial bearing boss 52 of the ring gear 13 or the first output shaft 7. Preferably, the second radial bearing 44 lies on the one hand permanently against the fastening means 51 and on the other hand permanently against the axial bearing boss 52.

The axial bearing bosses 50 and 52 may be different from each other and in particular they may be arranged with a spacing from each other in the axial direction. The axial bearing bosses 50 and 52 may also be designed as a common axial bearing boss, however, wherein the first radial bearing 43 is present on one side and the second radial bearing 44 on the side of this common axial bearing boss facing away in the axial direction. It will be clear that the bearing arrangement 42, i.e., both the first radial bearing 43 and the second radial bearing 44, is fastened merely across the bearing element 35 to the transmission housing 16. The radial bearings 43 and 44 thus engage with the transmission housing 16 solely across the bearing element 35.

Furthermore, it can be seen that the first bearing boss 36 comprises a first region 53 as well as a second region 54, which are different in regard to their diameters. Thus, the first bearing boss 36 has a first diameter in the first region 53 and a second diameter in the second region 54, the first diameter being larger than the second diameter. The first region 53 preferably borders on the center post 40, in any case it is situated on the side of the second region 54 facing toward the center post 40. The two regions 53 and 54 preferably adjoin each other directly in the axial direction with respect to the axis of rotation 19.

The first radial bearing 43 now sits in the first region 53 and the second radial bearing 44 in the second region 54 on the first bearing boss 36. Accordingly, the inner ring 45 has a larger diameter than the inner ring 46. Preferably, the radial bearings 43 and 44 are the same size in the radial direction, so that analogously to the inner rings 45 and 46 the outer ring 47 has a larger diameter than the outer ring 48. Of course, however, the radial bearings 43 and 44 may be chosen such that the diameter difference between the inner rings 45 and 46 is different from the diameter difference of the outer rings 47 and 48. For example, the inner rings 45 and 46 are designed with different diameters, while the outer rings 47 and 48 have the same diameter.

FIG. 4 shows a second embodiment of the final drive 1, once again in a sectional representation. Basically, reference is made to the preceding remarks and only the differences will be discussed below. These are due to the fact that the radial bearings 43 and 44 of the bearing arrangement 42 are now situated in a tandem arrangement to each other. Alternatively, an arrangement of the radial bearings 43 and 44 in an X arrangement or once again—as already explained above—a configuration of the radial bearings 43 and 44 as a fixed bearing and a floating bearing would also be possible. In the following, we shall discuss the tandem arrangement more closely. However, the remarks may be applied to the X arrangement and the configuration as a fixed bearing and floating bearing.

The first radial bearing 43 is arranged analogously to the first embodiment of the final drive 1. Accordingly, it sits by its inner ring 45 on the first bearing boss 36. In the axial direction it is braced preferably against the center post 40 on the one hand and against the axial bearing boss 50 on the other hand. However, there are differences with respect to the second radial bearing 44. This sits by its inner ring 45 on an outer bearing face 55 of the ring gear 13 or the first output shaft 7. Thus, while the first radial bearing 43 engages with the ring gear 13 or the output shaft 7, the second radial bearing 44 encloses the ring gear 13 or the output shaft 7. Consequently, the first bearing boss 36 may be shorter and have a uniform diameter. The fastening means 51 may also be eliminated.

The second radial bearing 44 engages on the one hand with the ring gear 13 or the output shaft 7 and on the other hand directly with the transmission housing 16, especially the two housing shells 22 and 23. The axial bearing boss 52 is now formed by a bearing shoulder of the ring gear 13 or the output shaft 7. This, in turn, can be represented by means of a change in diameter. In order to secure the second radial bearing 44 at least on the outside in the axial direction relative to the transmission housing 16, the transmission housing 16 likewise has an axial bearing boss 56. This is preferably formed both on the first housing shell 22 and on the second housing shell 23. The second radial bearing 44 now lies between the axial bearing boss 52 and the axial bearing boss 56, looking in the axial direction with respect to the axis of rotation 19. Especially preferably, it lies permanently against axial bearing boss 52 on the one hand and permanently against the axial bearing boss 56 on the other hand.

FIG. 5 shows a first variant of a third embodiment of the final drive 1. Once again, a schematic cross sectional representation is shown according to the preceding remarks. The bearing arrangement 42 is designed analogously to the second embodiment described above. However, it is also possible to use a bearing arrangement 42 according to the first embodiment. In this respect, reference it made to the preceding remarks. In the following, only the differences from the first embodiment shall be discussed. These consist in the fact that the ring gears 13 and 15 and hence the axes of rotation 19 and 20 do not run parallel to each other, but instead are angled relative to each other.

This means that the axes of rotation 19 and 20 furthermore intersect the axes of rotation 17 and 18 at the points of intersection 33 and 34, while the points of intersection 33 and 34 may coincide. Quite generally put, the axes of rotation 19 and 20 respectively intersect both axes of rotation 17 and 18. The axes of rotation 19 and 20 may additionally intersect each other or alternatively be arranged skew to each other, especially spaced apart parallel to each other. In a first variant shown here, the axes of rotation 19 and 20 intersect each other. The axes of rotation 19 and 20 are each angled by the same angle relative to the axis plane 21 or the plane of contact 24, so that the plane standing perpendicular to the plane of contact 24 and containing the axes of rotation 17 and 18 serves as the plane of symmetry for the axes of rotation 19 and 20.

FIG. 6 shows a second variant of the third embodiment. A sectional representation through the final drive is shown, namely, a longitudinal section view with respect to the axis of rotation 17 and 18. The sectioning plane has been chosen such that the viewing direction is toward the first housing shell 22. Reference is made expressly to the preceding remarks. In addition to these, it is now clearly recognizable here that the ring gears 12 and 14 of the ring gear transmissions 6 and 9 are arranged on opposite sides of the bearing element 35. For this—as already explained above—the second input shaft 4 passes through the bearing element 35, in particular it passes through the through opening 41. The direction of driving of the motor vehicle associated with the final drive 1 is indicated by the arrow 57.

In addition or alternatively to the first variant described above, in which the axes of rotation 19 and 20 are angled with respect to the axis plane, it may now be provided that the axes of rotation 19 and 20 are also set off from each other in the axial direction with respect to the axes of rotation 17 and 18. For example, the ring gear transmissions 6 and 9 are configured such that a cone angle is present, which is different from 90°. In the context of the above described embodiments and the first variant, on the other hand, the cone angle is preferably equal to 90°. The mutual displacement of the axes of rotation 19 and 20 in the axial direction produces two points of intersection 33 and 34 spaced apart from each other.

The described final drive 1 makes possible an extremely compact configuration. This holds especially when a further transmission mechanism is arranged on the side of the input shafts 2 and 4 facing away from the final drive 1, especially a differential transmission, preferably an axle differential transmission. Thus, the final drive 1 serves merely to produce the permanent operative connections between the first input shaft 2 and the first output shaft 7 on the one hand and the second input shaft 4 and the second output shaft 10 on the other hand.

1-10. (canceled)

11. A final drive for a motor vehicle, comprising:
a first input shaft, a second input shaft, a first output shaft, and a second output shaft, wherein the first input shaft is permanently coupled to the first output shaft by a first ring gear transmission and the second input shaft is permanently coupled to the second output shaft by a second ring gear transmission, wherein the first input shaft and the second input shaft are arranged coaxial to each other and the first output shaft and the second output shaft extend from the respective ring gear transmission in opposite directions,
wherein an axis plane contains the axes of rotation of the input shafts and a plane perpendicular to the axis plane makes an angle of at least 75° and at most 90° with each of the axes of rotation of the output shafts, and that a first ring gear of the first ring gear transmission, which first ring gear is rigidly connected to the first output shaft, and/or a second ring gear of the second ring gear transmission, which second ring gear is rigidly connected to the second output shaft, is mounted in a transmission housing of the final drive in each case by means of a first radial bearing and a second radial bearing, which are arranged in tandem arrangement or in X arrangement to each other or are designed as a fixed bearing and as a floating bearing.

12. The final drive as claimed in claim 11, wherein the axes of rotation of the two input shafts and the axes of rotation of the two output shafts lie in the axis plane.

13. The final drive as claimed in claim 11, wherein a bearing element is arranged in the transmission housing, comprising a first bearing boss and a second bearing boss, wherein the ring gear of the first ring gear transmission is mounted on the first bearing boss and the ring gear of the second ring gear transmission is mounted on the second bearing boss.

14. The final drive as claimed in claim 11, wherein the first radial bearing is arranged on the first bearing boss or the second bearing boss for the mounting of the respective ring gear, and/or the second radial bearing is arranged on the transmission housing.

15. The final drive as claimed in claim 11, wherein the first radial bearing lies against an inner bearing face of the respective ring gear and the second radial bearing lies against an outer bearing face of the respective ring gear or the output shaft connected to the ring gear.

16. The final drive as claimed in claim 11, wherein the first bearing boss and the second bearing boss emerge from a center post of the bearing element.

17. The final drive as claimed in claim 11, wherein the first radial bearing is braced against the center post in the axial direction with respect to an axis of rotation of the respective ring gear.

18. The final drive as claimed in claim 11, wherein the bearing element, especially the center post, is fastened to the transmission housing, while the first radial bearing is connected to the transmission housing only via the bearing element.

19. The final drive as claimed in claim 11, wherein the first radial bearing has a first inner diameter and a first outer diameter and the second radial bearing has a second inner diameter and a second outer diameter, while the first inner diameter is different from the second inner diameter and/or the first outer diameter is different from the second outer diameter.

20. The final drive as claimed in claim 11, wherein the first inner diameter is larger than the second inner diameter and/or the first outer diameter is larger than the second outer diameter.

21. The final drive as claimed in claim 12, wherein a bearing element is arranged in the transmission housing, comprising a first bearing boss and a second bearing boss, wherein the ring gear of the first ring gear transmission is mounted on the first bearing boss and the ring gear of the second ring gear transmission is mounted on the second bearing boss.

22. The final drive as claimed in claim 12, wherein the first radial bearing is arranged on the first bearing boss or the second bearing boss for the mounting of the respective ring gear, and/or the second radial bearing is arranged on the transmission housing.

23. The final drive as claimed in claim 13, wherein the first radial bearing is arranged on the first bearing boss or the second bearing boss for the mounting of the respective ring gear, and/or the second radial bearing is arranged on the transmission housing.

24. The final drive as claimed in claim 12, wherein the first radial bearing lies against an inner bearing face of the respective ring gear and the second radial bearing lies against an outer bearing face of the respective ring gear or the output shaft connected to the ring gear.

25. The final drive as claimed in claim 13, wherein the first radial bearing lies against an inner bearing face of the respective ring gear and the second radial bearing lies against an outer bearing face of the respective ring gear or the output shaft connected to the ring gear.

26. The final drive as claimed in claim 14, wherein the first radial bearing lies against an inner bearing face of the respective ring gear and the second radial bearing lies against an outer bearing face of the respective ring gear or the output shaft connected to the ring gear.

27. The final drive as claimed in claim 12, wherein the first bearing boss and the second bearing boss emerge from a center post of the bearing element.

28. The final drive as claimed in claim 13, wherein the first bearing boss and the second bearing boss emerge from a center post of the bearing element.

29. The final drive as claimed in claim 14, wherein the first bearing boss and the second bearing boss emerge from a center post of the bearing element.

30. The final drive as claimed in claim 15, wherein the first bearing boss and the second bearing boss emerge from a center post of the bearing element.
